(19) United States
(12) Patent Application Publication
(10) Pub. No.: US 2022/0367961 A1
(43) Pub. Date: Nov. 17, 2022

(54) POWER STORAGE MODULE

(71) Applicant: TOYOTA JIDOSHA KABUSHIKI KAISHA, Toyota-shi Aichi-ken (JP)

(72) Inventor: Naoya Kawamoto, Nisshin-shi Aichi-ken (JP)

(21) Appl. No.: 17/737,182

(22) Filed: May 5, 2022

(30) Foreign Application Priority Data
May 17, 2021 (JP) 2021-083018

(51) Int. Cl. H01M 50/293; H01M 10/658

(52) U.S. Cl. CPC H01M 50/293; H01M 10/658; H01M 2220/20

(57) ABSTRACT

A power storage module includes a pair of power storage cells and a spacer. Each power storage cell includes opposing surfaces. The spacer includes a skeleton member arranged between the opposing surfaces and an elastic member that is arranged between the opposing surfaces and is elastically deformable in an opposing direction. The skeleton member includes a central opposing portion formed at a position opposed to a central portion of the opposing surface. The elastic member is larger in thickness than the central opposing portion and is in contact with the opposing surfaces. The elastic member is lower in melting point than the central opposing portion.

### CROSS REFERENCE TO RELATED APPLICATIONS

This nonprovisional application claims priority to Japanese Patent Application No. 2021-083018 filed with the Japan Patent Office on May 17, 2021, the entire contents of which are hereby incorporated by reference.

### BACKGROUND

### Field

The present disclosure relates to a power storage module.

### Description of the Background Art

For example, Japanese Patent Laying-Open No. 2020-68101 discloses a power storage device including a first power storage cell and a second power storage cell arranged adjacently to each other, a partition plate arranged between the first power storage cell and the second power storage cell, and a spacer arranged to pass through the partition plate. External force in a direction in which the first power storage cell and the second power storage cell are brought closer to each other is constantly applied to the first power storage cell and the second power storage cell. The partition plate is composed of a thermoplastic resin. The spacer is composed of an inorganic material. The spacer has opposing ends exposed at surfaces of the partition plate, and the opposing ends are in contact with the first power storage cell and the second power storage cell.

When a temperature, for example, of the first power storage cell increases due to overcharging or the like in this power storage device, the partition plate is molten. Since the spacer is formed of the inorganic material, the spacer remains between the first power storage cell and the second power storage cell without being molten. Since a space is thus provided between the first power storage cell and the second power storage cell, the first power storage cell and the second power storage cell are effectively thermally insulated from each other.

### SUMMARY

In the power storage device described in Japanese Patent Laying-Open No. 2020-68101, the spacer composed of the inorganic material is constantly in contact with the first power storage cell and the second power storage cell, and hence it is difficult to adjust a restraint load with which each power storage cell is restrained.

An object of the present disclosure is to provide a power storage module capable of achieving both of thermal insulation between power storage cells and adjustment of a restraint load.

A power storage module according to one aspect of the present disclosure includes a pair of power storage cells arranged adjacently to each other and a spacer arranged between the pair of power storage cells. Each power storage cell of the pair of power storage cells includes opposing surfaces opposed to each other. The spacer includes a skeleton member arranged between the opposing surfaces of the pair of power storage cells and an elastic member that is arranged between the opposing surfaces and is elastically deformable in an opposing direction in which the opposing surfaces are opposed to each other. The skeleton member includes a central opposing portion formed at a position opposed to a central portion of each of the opposing surfaces. The elastic member is larger in thickness than the central opposing portion and is in contact with the opposing surfaces. The elastic member is lower in melting point than the central opposing portion.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view schematically showing a part of a construction of a power storage module in one embodiment of the present disclosure.

FIG. 2 is a cross-sectional view of the power storage module along a plane that passes through a skeleton member.

FIG. 3 is a cross-sectional view along the line III-III in FIG. 2.

FIG. 4 is a cross-sectional view schematically showing a state that a power storage cell generates heat.

### DETAILED DESCRIPTION

An embodiment of the present disclosure will be described with reference to the drawings. The same or corresponding members in the drawings referred to below have the same reference characters allotted.

FIG. 1 is a perspective view schematically showing a part of a construction of a power storage module in one embodiment of the present disclosure. This power storage module 1 is mounted, for example, on a vehicle.

As shown in FIG. 1, power storage module 1 includes a plurality of power storage cells 100 including a pair of power storage cells 100, at least one spacer 200, and a pair of side bands 300. The number of power storage cells 100 and spacers 200 is not particularly limited.

The pair of power storage cells 100 is arranged as being opposed to each other. Examples of power storage cell 100 include a lithium ion battery. Each power storage cell 100 includes a casing 110 and a pair of external terminals 120.

An electrode or the like (not shown) is accommodated in casing 110. Casing 110 is formed in a shape of a parallelepiped. Casing 110 is formed to have a flat profile. Casing 110 includes an opposing surface 112 opposed to casing 110 of adjacent power storage cell 100. Opposing surface 112 is formed as being flat. In the present embodiment, opposing surface 112 is formed from a side surface relatively large in area among four side surfaces of casing 110. In other words, the pair of power storage cells 100 is arranged as being aligned in a direction of thickness of each casing 110.

Each external terminal 120 protrudes from an outer surface (an upper surface in the present embodiment) of casing 110. One of the pair of external terminals 120 is a positive electrode terminal and the other is a negative electrode terminal.

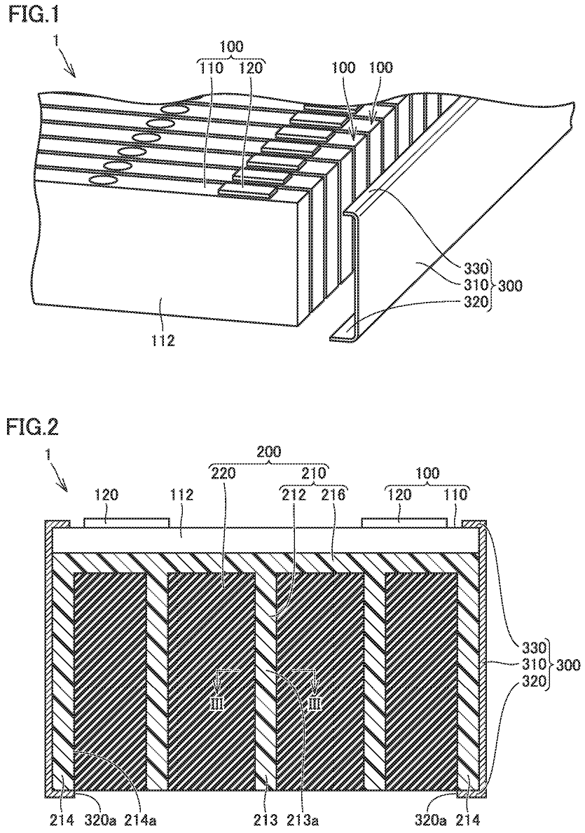

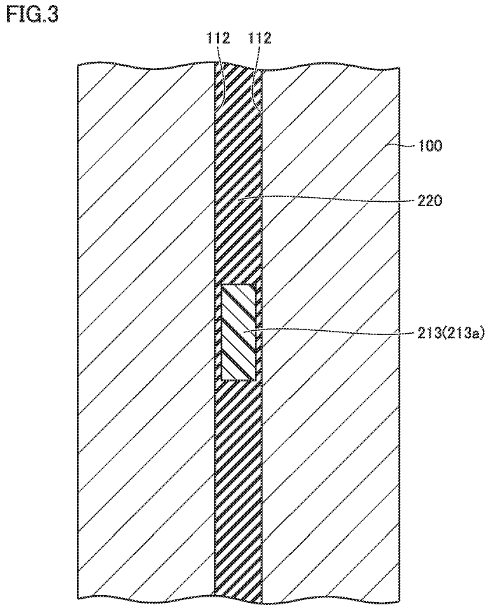

Spacer 200 is arranged between the pair of power storage cells 100. More specifically, spacer 200 is arranged between opposing surfaces 112 of respective casings 110. As shown in FIGS. 2 and 3, spacer 200 includes a skeleton member 210 and an elastic member 220.

Skeleton member 210 is arranged between opposing surfaces 112. Skeleton member 210 is composed of a thermoplastic resin (a phenol resin or the like). Skeleton member 210 includes a plurality of skeleton portions 212 and a coupling portion 216.

The plurality of skeleton portions 212 are arranged as being aligned at intervals in a width direction orthogonal to both of an opposing direction (the direction of thickness of casing 110) in which opposing surfaces 112 are opposed to each other and an upward/downward direction. In the present embodiment, the plurality of skeleton portions 212 are arranged as being aligned at regular intervals in the width direction. As shown in FIG. 2, each skeleton portion 212 is in a shape extending in the upward/downward direction. A space between skeleton portions 212 adjacent to each other in the width direction opens downward. Though FIG. 2 shows five skeleton portions 212, the number of skeleton portions 212 is not limited as such.

The plurality of skeleton portions 212 include a central skeleton portion 213 and an end skeleton portion 214. Central skeleton portion 213 is arranged at the center in the width direction. Central skeleton portion 213 includes a central opposing portion 213a formed at a position opposed to a central portion of opposing surface 112. The central portion of opposing surface 112 means a part of opposing surface 112 located at the center in the upward/downward direction and at the center in the width direction. End skeleton portion 214 is arranged at an end in the width direction. End skeleton portion 214 is opposed to an end of opposing surface 112 in the width direction.

Coupling portion 216 couples a plurality of skeleton portions 212 to each other. In the present embodiment, coupling portion 216 couples upper ends of skeleton portions 212 to each other. The upper end of coupling portion 216 is arranged at a position lower than the upper surface of casing 110. A dimension of coupling portion 216 in the upward/downward direction may be set to be equal to a dimension of skeleton portion 212 in the width direction.

Elastic member 220 is arranged between opposing surfaces 112 and is elastically deformable in the opposing direction. Elastic member 220 is in contact with opposing surfaces 112 opposed to each other. Elastic member 220 is shaped to fill interstices between skeleton portions 212 adjacent to each other in the width direction. Elastic member 220 may be bonded to skeleton member 210 or may be formed integrally with skeleton member 210 by insert molding or the like. Elastic member 220 is composed of a material lower in melting point than skeleton member 210. Elastic member 220 is composed of ethylene propylene diene monomer (EPDM), urethane foam, or the like. Elastic member 200 has a surface formed as being flat.

FIG. 3 shows a state that the plurality of power storage cells 100 are restrained (compressed) by a not-shown restraining member from opposing sides in the opposing direction. While the plurality of power storage cells 100 and spacer 200 are restrained, elastic member 220 is larger in thickness than each skeleton portion 212.

Side bands 300 are arranged on opposing sides of the plurality of power storage cells 100 in the width direction. Side bands 300 sandwich the plurality of power storage cells 100 from the opposing sides in the width direction. Side band 300 includes a sidewall 310, a receiving portion 320, and an upper wall 330. FIG. 1 shows only side band 300 arranged on one side in the width direction.

Sidewall 310 is in a shape extending in the opposing direction. Sidewall 310 is formed in a shape of a flat plate. As shown in FIGS. 1 and 2, sidewall 310 extends from a lower end to an upper end of casing 110.

Receiving portion 320 is in a shape protruding from a lower end of sidewall 310 inward in the width direction. Receiving portion 320 receives skeleton member 210 from below. More specifically, receiving portion 320 receives end skeleton portion 214.

As shown in FIG. 2, in some embodiments, an end 320a on an inner side of receiving portion 320 in the width direction is superimposed in the upward/downward direction on an end 214a on an inner side of end skeleton portion 214 in the width direction, or located on a further outer side in the width direction. Thus, superimposition of a space between skeleton portions 212 adjacent in the width direction on receiving portion 320 in the upward/downward direction is suppressed.

Upper wall 330 is in a shape protruding from an upper end of sidewall 310 inward in the width direction. Upper wall 330 is engaged with the upper surface of casing 110.

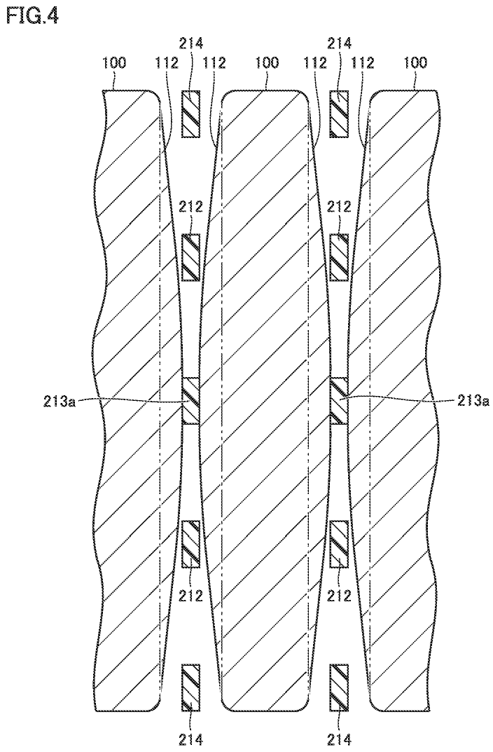

As described above, in power storage module 1 in the present embodiment, elastic member 220 larger in thickness than central opposing portion 213a is in contact with opposing surfaces 112 of power storage cells 100. Therefore, a restraint load with which a plurality of power storage cells 100 are collectively restrained from the opposing sides in the opposing direction can be adjusted. Furthermore, since elastic member 220 is lower in melting point than skeleton portion 212, with increase in temperature of a specific power storage cell 100 to a melting point of elastic member 220 due to overcharging or the like, elastic member 220 is molten whereas each skeleton portion 212 remains. Therefore, even when casing 110 expands in such a manner that opposing surfaces 112 of power storage cells 100 come closer to each other as shown in FIG. 4, a space is secured between the pair of power storage cells 100 and power storage cells 100 are effectively thermally insulated from each other. Therefore, this power storage module 1 achieves both of thermal insulation between power storage cells 100 and adjustment of the restraint load. FIG. 4 shows opposing surfaces 112 of casings 110 before expansion with a chain double dotted line.

In the embodiment, skeleton portions 212 may be arranged at intervals in the upward/downward direction and may each be in a shape extending in the width direction. Alternatively, each skeleton portion 212 may be inclined as intersecting with both of the upward/downward direction and the width direction. In these cases as well, one skeleton portion 212 of the plurality of skeleton portions includes central opposing portion 213a formed at a position opposed to the central portion of opposing surface 112.

An illustrative embodiment described above is understood by a person skilled in the art as specific examples of aspects below.

The power storage module in the embodiment includes a pair of power storage cells arranged adjacently to each other and a spacer arranged between the pair of power storage cells. Each power storage cell of the pair of power storage cells includes opposing surfaces opposed to each other. The spacer includes a skeleton member arranged between the opposing surfaces of the pair of power storage cells and an elastic member that is arranged between the opposing surfaces and is elastically deformable in an opposing direction in which the opposing surfaces are opposed to each other. The skeleton member includes a central opposing portion formed at a position opposed to a central portion of each of the opposing surfaces. The elastic member is larger in thickness than the central opposing portion and is in contact with the opposing surfaces. The elastic member is lower in melting point than the central opposing portion.

In this power storage module, the elastic member larger in thickness than the central opposing portion is in contact with the opposing surfaces of the power storage cells. Therefore, a restraint load with which the pair of power storage cells is restrained can be adjusted. Furthermore, since the elastic member is lower in melting point than the central opposing portion, with increase in temperature of a specific power storage cell to a melting point of the elastic member due to overcharging or the like, the elastic member is molten whereas the central opposing portion remains. Therefore, even when the power storage cell expands in such a manner that the opposing surfaces of the power storage cells come closer to each other, a space is secured between the pair of power storage cells and the power storage cells are effectively thermally insulated from each other. Therefore, this power storage module achieves both of thermal insulation between the power storage cells and adjustment of the restraint load.

In some embodiments, the skeleton member includes a plurality of skeleton portions arranged as being aligned at intervals in the width direction orthogonal to both of the opposing direction and the upward/downward direction, the elastic member is shaped to fill interstices between the skeleton portions adjacent to each other in the width direction among the plurality of skeleton portions, the plurality of skeleton portions include a central skeleton portion arranged at the center in the width direction, and the central skeleton portion includes the central opposing portion.

By doing so, an elastic portion is arranged between the skeleton portions adjacent in the width direction. Therefore, the restraint load is made uniform over the width direction.

In this case, in some embodiments, the skeleton member further includes a coupling portion that couples the plurality of skeleton portions to each other.

Handling of the skeleton member is thus facilitated.

Furthermore, in some embodiments, each skeleton portion of the plurality of skeleton portions is in a shape extending in the upward/downward direction, and the coupling portion couples upper ends of the skeleton portions to each other.

By doing so, deposition on the coupling portion, of the elastic member molten at the time of heat generation from the power storage cell is suppressed.

In some embodiments, a space between the skeleton portions adjacent to each other in the width direction opens downward.

By doing so, the molten elastic member is discharged downward below the skeleton member. Therefore, the opposing surfaces opposed to each other being held in a contact state with the molten elastic member being interposed is suppressed.

The power storage module may further include a receiving portion that receives the skeleton member from below. In this case, in some embodiments, the plurality of skeleton portions include an end skeleton portion arranged at the end in the width direction and the receiving portion receives the end skeleton portion.

In this aspect, since the receiving portion receives the end skeleton portion, falling of the skeleton member from between the pair of power storage cells is suppressed.

Though an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. A power storage module comprising:
a pair of power storage cells arranged adjacently to each other; and
a spacer arranged between the pair of power storage cells, wherein
each power storage cell of the pair of power storage cells includes opposing surfaces opposed to each other,
the spacer includes
a skeleton member arranged between the opposing surfaces of the pair of power storage cells, and
an elastic member that is arranged between the opposing surfaces and is elastically deformable in an opposing direction in which the opposing surfaces are opposed to each other,
the skeleton member includes a central opposing portion formed at a position opposed to a central portion of each of the opposing surfaces,
the elastic member is larger in thickness than the central opposing portion and is in contact with the opposing surfaces, and
the elastic member is lower in melting point than the central opposing portion.

2. The power storage module according to claim 1, wherein
the skeleton member includes a plurality of skeleton portions arranged as being aligned at intervals in a width direction orthogonal to both of the opposing direction and an upward/downward direction,
the elastic member is shaped to fill interstices between the skeleton portions adjacent to each other in the width direction among the plurality of skeleton portions,
the plurality of skeleton portions include a central skeleton portion arranged at a center in the width direction, and
the central skeleton portion includes the central opposing portion.

3. The power storage module according to claim 2, wherein
the skeleton member further includes a coupling portion that couples the plurality of skeleton portions to each other.

4. The power storage module according to claim 3, wherein
each skeleton portion of the plurality of skeleton portions is in a shape extending in the upward/downward direction, and
the coupling portion couples upper ends of the skeleton portions to each other.

5. The power storage module according to claim 3, wherein
a space between the skeleton portions adjacent to each other in the width direction opens downward.

6. The power storage module according to claim 5, further comprising a receiving portion that receives the skeleton member from below, wherein
the plurality of skeleton portions include an end skeleton portion arranged at an end in the width direction, and
the receiving portion receives the end skeleton portion.
